(19) United States
(12) Patent Application Publication
(10) Pub. No.: US 2014/0108617 A1
(43) Pub. Date: Apr. 17, 2014

(54) DATA STORAGE IN CLOUD COMPUTING

(71) Applicant: Unisys Corporation, Blue Bell, PA (US)

(72) Inventor: Kurt Gerstner, Glen Carbon, IL (US)

(73) Assignee: Unisys Corporation, Blue Bell, PA (US)

(21) Appl. No.: 13/832,776

(22) Filed: Mar. 15, 2013

Related U.S. Application Data
(60) Provisional application No. 61/670,628, filed on Jul. 12, 2012.

(51) Int. Cl. H04L 29/08

(52) U.S. Cl. CPC H04L 67/06
USPC 709/219

(57) ABSTRACT

A redundant cloud storage solution may be created from individual cloud storage solutions. Files may be split into pieces and stored in separate cloud storage solutions and then retrieved from the cloud storage solutions to assemble the original file. When splitting the files, the data may be encrypted for additional security. Additionally, redundancy may be obtained by duplicating data across multiple cloud storage solutions, such as in a RAID level 5 configuration. A server may intervene between a client device and the cloud storage solutions to perform the file splitting, encrypting, and management functions. Thus, the client access to the redundant cloud solution may function as any other network drive.

### CROSS-REFERENCE TO RELATED APPLICATION

This application claims priority to U.S. Provisional Patent Application No. 61/670,628 filed Jul. 12, 2012 entitled “uDrop Software Architecture,” which is incorporated by reference in its entirety.

### FIELD OF THE DISCLOSURE

1. Field of the Disclosure

The instant disclosure relates to computer networks. More specifically, this disclosure relates to storing data in computer networks.

2. Background

Computer networks have evolved over time to offer higher bandwidth connections and lower latency times. Current computer networks are often capable of transferring large files between computers in remote locations in a matter of seconds. Thus, whether data is stored physically local to a computer device or at a remote location has little impact on the capability or speed to access the data.

Many computer users and network administrators have begun to rely on computer network-based storage for data. For example, network drives may be used to store several users' data. Thus, management of the data for several users is centralized. Centralized administration allows improved reliability by focusing resources on a common storage device, rather than having a storage device at each user's computer.

Computer users and network administrators have further reduced administration of storage devices by storing data in cloud computing systems. A cloud computing system is a collection of computer devices hosted remotely from the user's computer and is often managed by another entity. The user is generally unaware of details of the systems within the cloud, such as how man storage devices of what capacity are available. Instead, the user is allocated a certain portion of space and knows that portion of space is always available within the cloud.

Cloud computing systems offer users increased reliability over local or remote storage systems, because the cloud computing system is significantly larger than any local or remote system. Further, the job of maintaining the cloud computing system may be outsourced to another entity. Thus, cloud computing offers advantages over local or remote storage devices.

FIG. 1 is a block diagram illustrating a conventional cloud computing system. A system 100 includes a cloud 110. The cloud may include a number of computer systems 112a-c connected to a network 114.

However, cloud computing systems are still vulnerable to failure. When a cloud computing system fails, the user is not only without access to the data, but the user is also without access to backups. Further, because the maintenance of the cloud computing system is outsourced to another entity, the user has little input in the diagnostics and repair process. Thus, the user could be without access to their data for a prolonged period of time. When the data is mission-critical data this is an unacceptable storage solution.

### SUMMARY

Reliability of data may be improved by storing the data across several cloud storage solutions. For example, a data file may be stored in two or more cloud storage solutions. The data may be duplicated across multiple cloud storage solutions. Alternatively, the data may be split across multiple cloud storage solutions. According to one embodiment, the data may be split and duplicated across three or more cloud storage solutions in a redundant array of independent disks (RAID) level 5 arrangement.

Security of data may also be improved by storing the data across several cloud storage solutions. Data may be split and encrypted within one or more cloud storage solutions. When the data is split into separate files and encrypted, recreating the original data by an authorized user is more difficult. Further, when the encrypted data is split between two or more cloud storage solutions, security is further enhanced by increasing the difficulty of obtaining access to each piece of the data file.

A system may be designed to interact with the one or more cloud storage solutions to provide access to data stored in the cloud storage solutions. The system may include a server connected to a remote terminal and connected to the one or more cloud storage solutions. The server may receive requests from the remote terminal and process files to split and store among the cloud storage solutions and/or to recombine portions of the file retrieved from the cloud storage solutions. Access to the files in the cloud storage solutions, through the server, may be made available to remote terminals such as laptop computers, tablet computers, and mobile phones. The server may further allow synchronizing of files between devices.

According to one embodiment, a method includes receiving a file for remote storage. The method also includes splitting the file into a first part and a second part. The method further includes encrypting the first part and the second part. The method also includes uploading the encrypted first part to a first cloud storage solution. The method further includes uploading the encrypted second part to a second cloud storage solution.

According to another embodiment, a computer program product includes a non-transitory computer readable medium having code to receive a file for remote storage. The medium also includes code to split the file into a first part and a second part. The medium further includes code to encrypt the first part and the second part. The medium also includes code to upload the encrypted first part to a first cloud storage solution. The medium further includes code to upload the encrypted second part to a second cloud storage solution.

According to yet another embodiment, an apparatus includes a memory and a processor coupled to the memory. The processor is configured to receive a file for remote storage. The processor is also configured to split the file into a first part and a second part. The processor is further configured to encrypt the first part and the second part. The processor is also configured to upload the encrypted first part to a first cloud storage solution. The processor is further configured to upload the encrypted second part to a second cloud storage solution.

According to one embodiment, a method includes splitting a file into a first part and a second part. The method also includes generating parity information for the first part and the second part. The method further includes uploading the first part in a first cloud storage solution. The method also includes uploading the second part in a second cloud storage solution. The method further includes uploading the parity information in a third cloud storage solution.

According to another embodiment, a computer program product includes a non-transitory computer readable medium having code to split a file into a first part and a second part. The medium also includes code to generate parity information for the first part and the second part. The medium further includes code to upload the first part in a first cloud storage solution. The medium also includes code to upload the second part in a second cloud storage solution. The medium further includes code to upload the parity information in a third cloud storage solution.

According to yet another embodiment, an apparatus includes a memory and a processor coupled to the memory. The processor is configured to split a file into a first part and a second part. The processor is also configured to generate parity information for the first part and the second part. The processor is further configured to upload the first part in a first cloud storage solution. The processor is also configured to upload the second part in a second cloud storage solution. The processor is further configured to upload the parity information in a third cloud storage solution

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional cloud computing system.

FIG. 2 is a block diagram illustrating a redundant cloud storage solution according to one embodiment of the disclosure.

FIG. 3 is a flow chart illustrating a method for storing data in a redundant cloud storage solution according to one embodiment of the disclosure.

FIG. 4 is a block diagram illustrating a system for synchronizing a personal computer with a mobile device through the redundant cloud storage solution according to one embodiment of the disclosure.

FIG. 5 is a flow chart illustrating a method for storing data according to RAID level 5 in a redundant cloud storage solution according to one embodiment of the disclosure.

FIG. 6 is a flow chart illustrating operation of a web client with a redundant storage solution according to one embodiment of the disclosure.

FIG. 7 is a block diagram illustrating a security architecture for a redundant cloud storage solution according to one embodiment of the disclosure.

FIG. 8 is a flow chart illustrating a method for processing data on a device through a redundant storage solution according to one embodiment of the disclosure.

FIG. 9 is a block diagram illustrating stored information regarding data stored in a redundant storage solution according to one embodiment of the disclosure.

FIG. 10 is a block diagram illustrating a computer network according to one embodiment of the disclosure.

FIG. 11 is a block diagram illustrating a computer system according to one embodiment of the disclosure.

FIG. 12A is a block diagram illustrating a server hosting an emulated software environment for virtualization according to one embodiment of the disclosure.

FIG. 12B is a block diagram illustrating a server hosting an emulated hardware environment according to one embodiment of the disclosure.

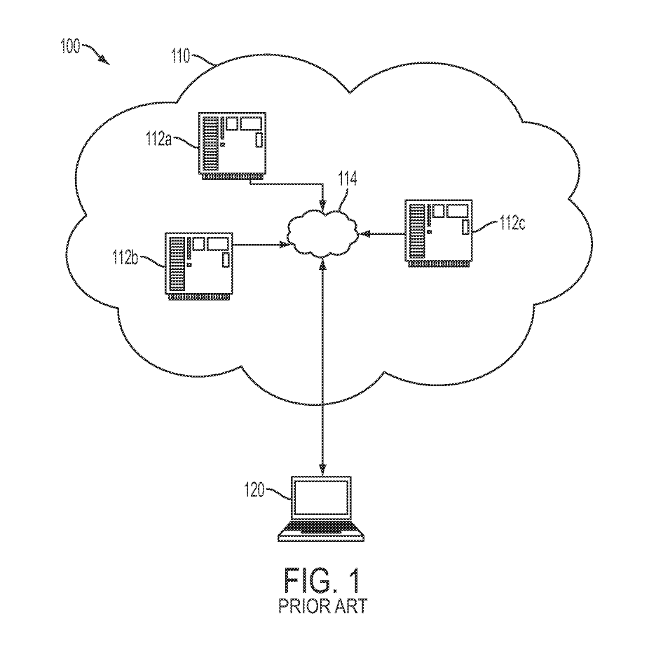

### DETAILED DESCRIPTION

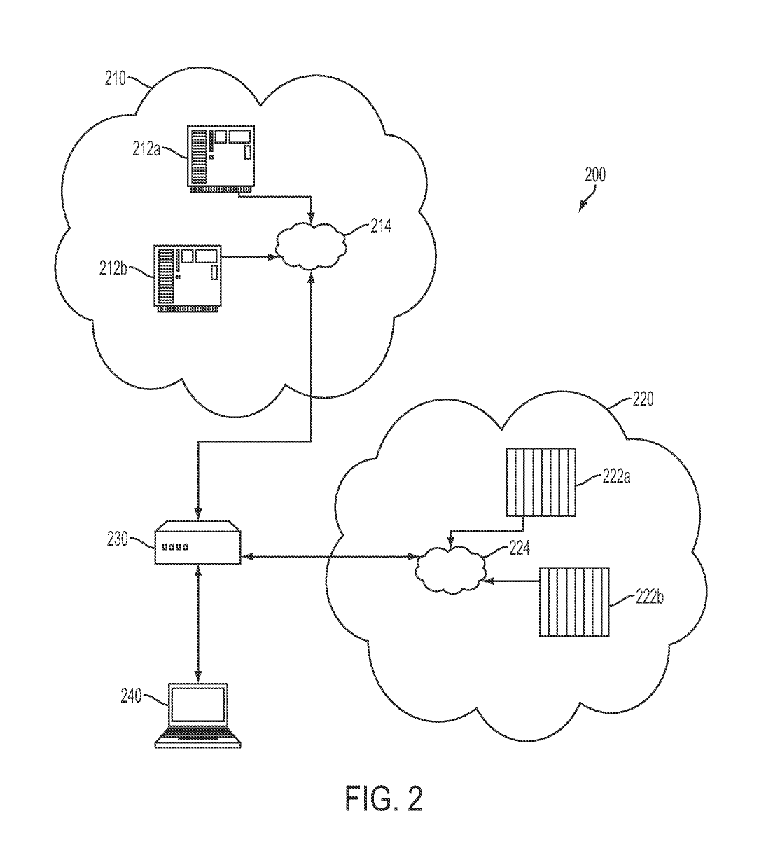

FIG. 2 is a block diagram illustrating a redundant cloud storage solution according to one embodiment of the disclosure. A redundant cloud storage solution 200 may include a server 230 connected to a client 240. The server 230 may provide an interface between the client 240 and cloud storage solutions 210 and 220. Although only two cloud storage solutions are illustrated, there may be more than two cloud storage solutions in the redundant cloud storage solution 200. The cloud storage solution 210 may include servers 212a-b connected to a network 214. The cloud storage solution 220 may include servers 222a-b connected to a network 224. The server 230 may be connected to the networks 214 and 224, however the server 230 may be unaware of the presence of servers 212a-b and servers 222a-b. Instead, the server 230 may have access to the cloud storage solutions 210 and 220 through a single network address or an application programming interface (API). The cloud storage solutions 210 and 220 may be provided by different hosting companies. For example, the cloud storage solution 210 may be hosted by the AMAZON S3 service, and the cloud storage solution 220 may be hosted by the GOOGLE DRIVE service.

The client 240 may interact with the server 230 while unaware of the presence of the cloud storage solutions 210 and 220. Instead, the client 240 may access the server 230 as any other network drive for storing files. The server 230 may then process files sent by and requested by the client 240. For example, the server 230 may split a file into two parts, encrypt the two parts, and store the two parts separately on the cloud storage solution 210 and the cloud storage solution 220. The client 240 may have special software installed to access the server 230.

In one embodiment, the client 240 may have direct access to the cloud storage solutions 210 and 220 without use of the server 230. That is, the client 240 may directly interact with the cloud storage solutions 210 and 220. For example, the client 240 may split a file into two parts, encrypt the two parts, and store the two parts separately on the cloud storage solutions 210 and the cloud storage solution 220.

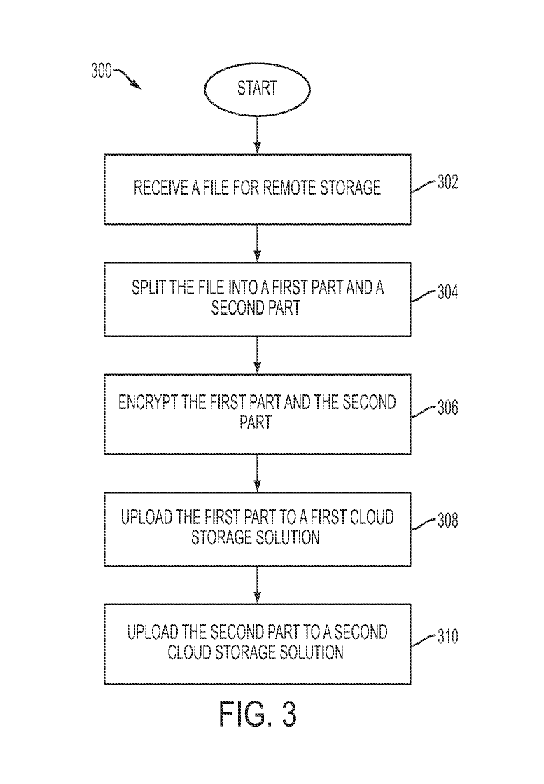

FIG. 3 is a flow chart illustrating a method for storing data in a redundant cloud storage solution according to one embodiment of the disclosure. A method 300 begins at block 302 with receiving, at a server, a file, from a client, for remote storage. At block 304, the file is split into a first part and a second part. The parts may be equal or unequal in size. The first part and the second part may also be identical copies of the data in the file. When the first part and the second part are identical, redundancy may be gained by storing the same data in two or more cloud storage solutions.

At block 306, the first part and the second part may be encrypted. The encryption may be, for example, a 128-bit secure sockets layer (SSL) encryption. Although encryption is illustrated in the method 300, encryption may be an optional enhancement to the redundant cloud storage solution. That is, encryption may be disabled for certain clients of a server, or all clients of a server, to improve performance of the redundant cloud storage solution by reducing processing of the data. A server encrypting the first part and the second part may have a different encryption certificate installed for each client. Thus, if multiple clients store data in the cloud storage solutions through the server, access to a client's files will be restricted to only the client that stored the file and thus has a copy of the encryption certificate.

At block 308, the first part of the file may be uploaded to a first cloud storage solution. At block 310, the second part of the file may be uploaded to a second cloud storage solution. The first and second cloud storage solution may be different cloud storage solutions. When the cloud storage solutions are different cloud storage solutions, security may be enhanced by physically separating the parts of the data file, in addition to encrypting the parts of the data file.

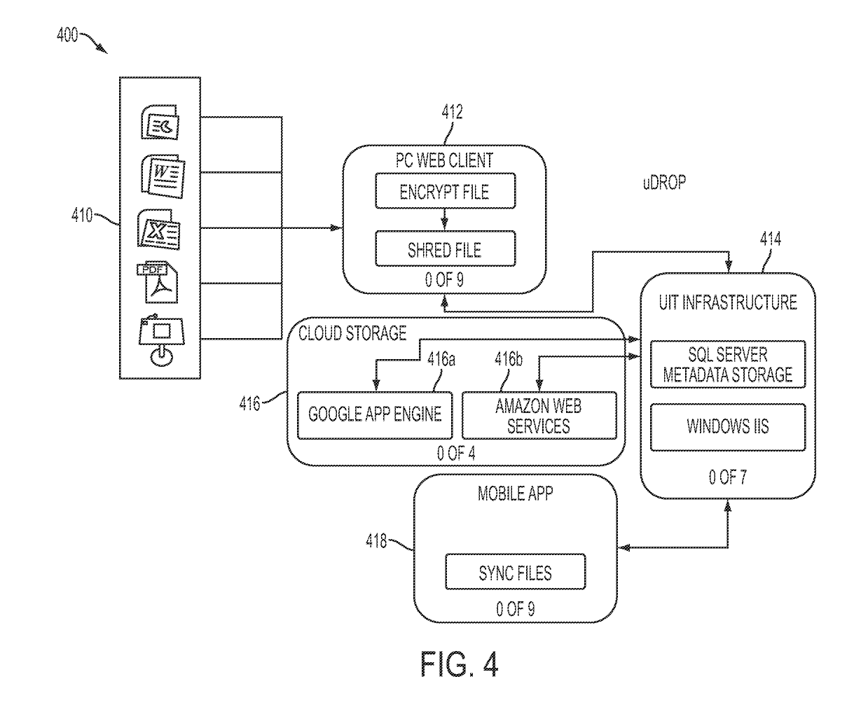

FIG. 4 is a block diagram illustrating a system for synchronizing a personal computer with a mobile device through the redundant cloud storage solution according to one embodiment of the disclosure. A system 400 may include a local data file 410, such as a document, spreadsheet, slide show, image, video, and/or audio file. The file 410 may be accessed by client software on a computer system 412. The client may execute on the computer system 412 as stand-alone software and/or may integrate with the operating system of the computer system 412 to provide access to the redundant cloud storage solution as though the storage was a local drive. In certain embodiments, the client may be a web-based interface to allow access to the redundant cloud storage solution on any computer system without installing software. The client on the computer system 412 may perform functions, such as encrypting the file, splitting the file into pieces, generating parity information for the file, and/or scanning the file for virus or malicious content.

The computer system 412 may be connected to a server 414, which may be executing server software such as a database server and a web server. The web server may receive data from the computer system 412, such as the file for storage in a cloud storage solution. The database server may store metadata regarding the split parts of the file. For example, the database server may store information linking pieces of a file to a particular cloud storage solution, pieces of a file to a particular file, a particular file to a particular user, and a particular user to particular permissions. The server 414 may also be connected to cloud storage solutions 416, such as a GOOGLE App Engine 416a and an AMAZON Web Service 416b.

A mobile application 418 may execute on a mobile device, such as a tablet computer and a mobile phone. The mobile app 418 may be connected with the server 414 and provide access to files stored in the cloud storage solutions 416. Additionally, the mobile app 418 may include additional modules, such as a file synchronization module. The file synchronization module may allow the mobile device to synchronize copies of files between a computer system 412 and the mobile device by detecting when a file changes and uploading the new file to or retrieving the new file from the server 414.

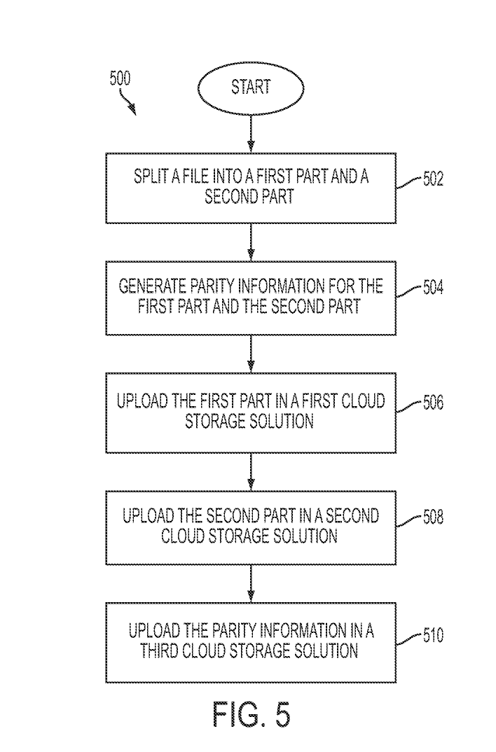

Additional reliability in a redundant cloud storage solution may be achieved by implementing a redundancy scheme, such as RAID level 5, within the cloud storage solutions. FIG. 5 is a flow chart illustrating a method for storing data according to RAID level 5 in a redundant cloud storage solution according to one embodiment of the disclosure. A method 500 begins at block 502 with splitting a file into a first part and a second part. At block 504, parity information may be generated for the first part and the second part. The parity information may be a single block of data calculated from the contents of the first part and the second part. Alternatively the parity information may be for only the first part or only the second part. In one embodiment, the parity information may be generated separately for both the first part and the second part.

At block 506, the first part may be uploaded to the first cloud storage solution, and at block 508, the second part may be uploaded to the second cloud storage solution. At block 510, the parity information may be uploaded in a third cloud storage solution. For example, when there is a single parity information for both the first and second parts, the parity information may be stored in the third cloud storage solution. If multiple pieces of parity information are generated, the parity information may all be stored in the third cloud storage solution, or parts of the parity information may be stored in one of the first or second cloud storage solutions or a fourth cloud storage solution.

The RAID level 5 configuration of cloud storage devices may offer improved reliability of the data. For example, if one of the cloud storage solutions becomes unavailable, then files may still be recovered from the remaining other cloud storage solutions.

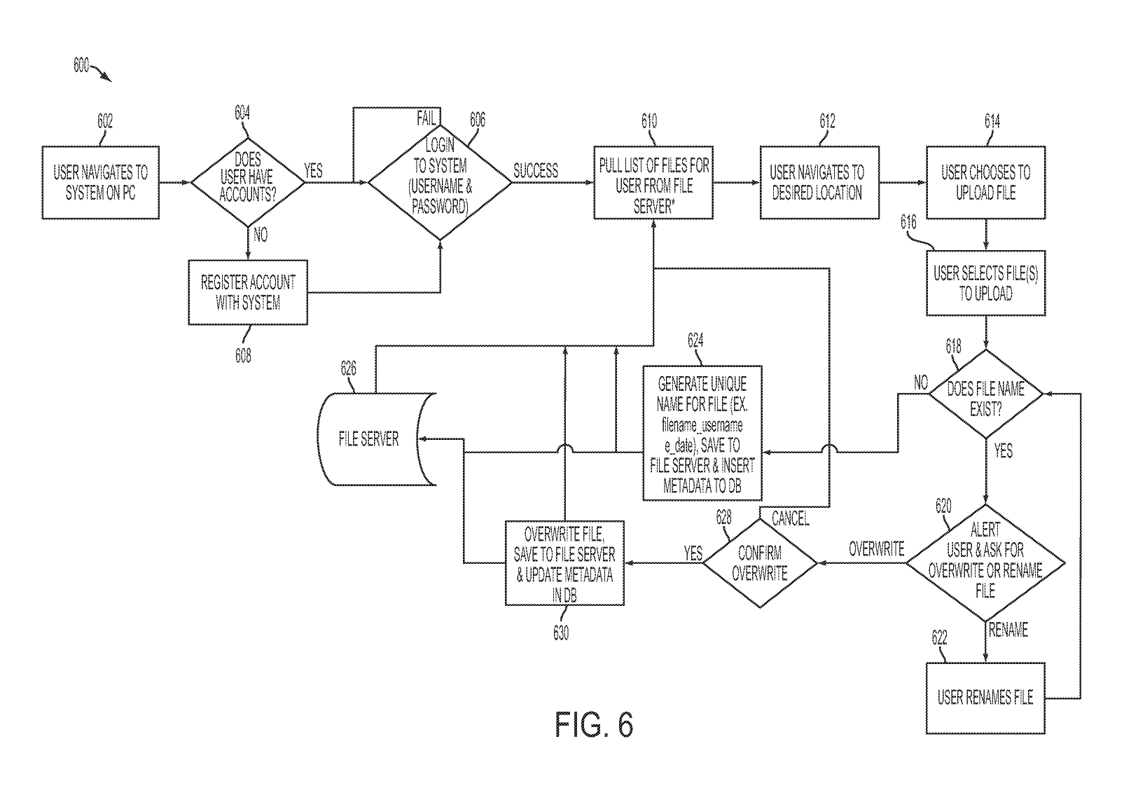

A client accessing a redundant cloud storage solution may operate according to the method illustrated in FIG. 6. FIG. 6 is a flow chart illustrating operation of a web client with a redundant storage solution according to one embodiment of the disclosure. A method 600 begins at block 602 with a user navigating to access the redundant cloud storage solution. For example, the user may type in a specific web address, execute a stand-alone application, and/or navigate to a particular folder through the operating system explorer. At block 604, it is determined whether the user has an account. If the user does not have an account, then the user registers an account with the redundant cloud storage solution at block 608 and proceeds to block 606. If the user does have an account, the method 600 proceeds directly to block 606.

At block 606, the user logs in to the system, such as by providing a username and password. The username may be, for example, an email address or an arbitrary identifier selected by the user during registration at block 608. If incorrect credentials are supplied, the user again attempts to log into the system at block 606. After the login is successful, then the list of files associated with the user's account is generated at block 610. The list of files may be transferred from the redundant cloud storage solution to the client. For example, a server may generate the list by accessing the cloud storage solutions and transmit the list to the client device.

At block 612, a user may navigate to a particular folder within their assigned storage area in the redundant cloud storage system. At block 614, the user chooses to upload a file, and at block 616, the user selects a file to upload. At block 618, it is determined whether a file with the same file name already exists. If so, the user is requested whether to overwrite or rename the file at block 620. If the user selects to rename the file, the user renames the file at block 622 and the method 600 returns to block 618. If the user selects to overwrite the file, the user may be requested to confirm their selection at block 628. If the user confirms their selection, the file is overwritten at block 630. If the user cancels the upload, the user is returned to block 610 to view the list of files in the assigned storage area.

If a file does not exist with the file name at block 618, then a unique name for the file may be generated at block 624. The unique name may include information such as a filename, a username, and a date. The unique name may be stored in a database server as metadata that is associated with the file selected for upload at block 616. At block 626, the file is uploaded to the file server, and the method 600 returns to block 610 to allow the user to view the list of files in the assigned storage area. After the file is uploaded to the file server at block 626, the file server may split and/or encrypt the file into parts and upload the parts to one or more cloud storage solutions.

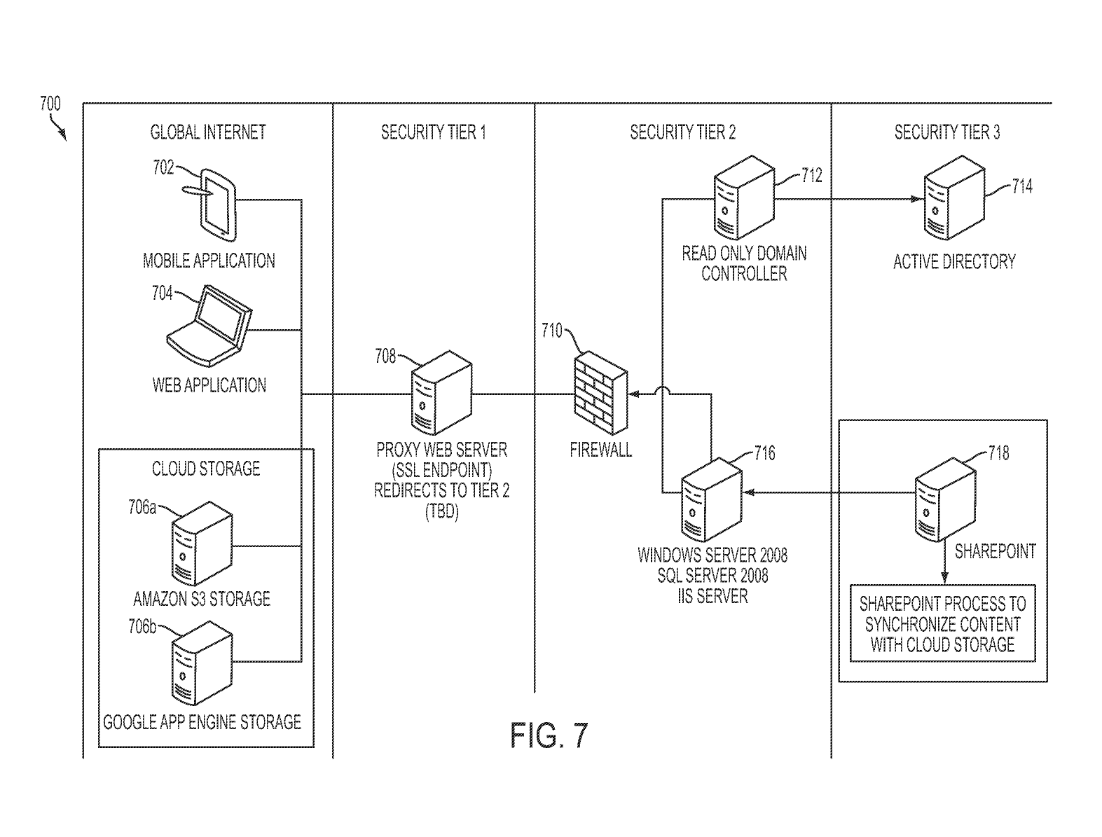

Security may be provided through additional servers between the client and the redundant cloud storage solution. FIG. 7 is a block diagram illustrating a security architecture for a redundant cloud storage solution according to one embodiment of the disclosure. A system 700 may include a mobile device 702 executing a mobile application for accessing the redundant cloud storage solution, and a device 704 accessing a web-based application to access the redundant cloud storage solution.

The devices 702 and 704 may access a network through a proxy web server 708, which provides a first tier of security. The proxy web server 708 may be coupled to a firewall 710, which provides a second tier of security along with a domain controller 712 and a server 716, such as a WINDOWS server. The server 716 may host application logic for the redundant cloud storage solution along with metadata for files stored in the redundant cloud storage solution. A third tier of security may be provided by an active directory server 714 coupled to the domain controller 712 and a server 718 coupled to the server 716. The server 718 may provide access to the redundant storage solution, which accesses cloud storage solutions 706a-b.

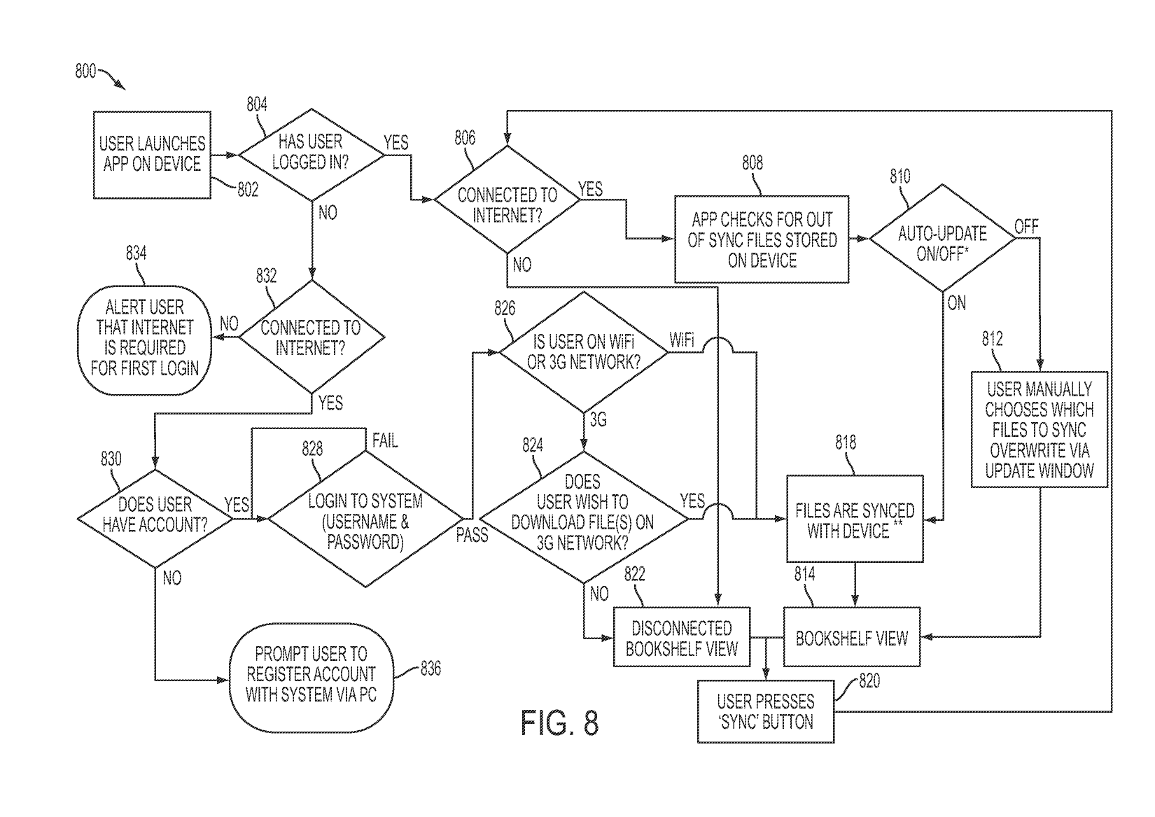

FIG. 8 is a flow chart illustrating a method for processing data on a device through a redundant storage solution according to one embodiment of the disclosure. A method 800 begins at block 802 with a user launching an application that accesses the redundant cloud storage solution. At block 804, it is determined whether the user has logged in. If so, it is determined whether the device is connected to the Internet at block 806. If so, then the application on the device checks for out of sync files stored on the device at block 808. At block 810, it is determined whether auto-update is enabled in the application. If so, then the out-of-sync files are synchronized at block 818 and the user is shown a bookshelf view at block 814. After the sync is complete, the method 800 may return to checking for out-of-sync files at block 808. If auto-update is off at block 810, the user may manually choose which files to sync at block 812. Then, at block 814, the bookshelf view is presented to the user, from which the user may press the sync button at block 820. After sync at block 820, the method 800 returns to block 806. If no internet is detected at block 806, then the method 800 proceeds to block 822 to display a disconnected bookshelf view to the user at block 822.

If the user has not logged in at block 804, it is determined at block 832 whether the device is connected to the network. If not, the user may be alerted at block 834 that the application requires access to the network on first login. If the network is connected, then it may be determined whether the user has an account at block 830. If not, then the user may be prompted to register a new account at block 836. If the user has an account, then it is determined at block 828 whether the login using a username and password was successful. If not, the user is asked to repeat block 828 with a new username and password. If so, then it is determined at block 826 whether the user is on WiFi or a cellular data connection. If WiFi, then files may be synced at block 818. If cellular, then the user may be prompted at block 824 whether to sync files over the cellular network. The user may be warned that data charges may be incurred through the cellular network. If the user does not authorize use of the cellular connection, then the user may be displayed a disconnected bookshelf view at block 822. If the user does authorize use of the cellular connection, then files may be synced at block 818.

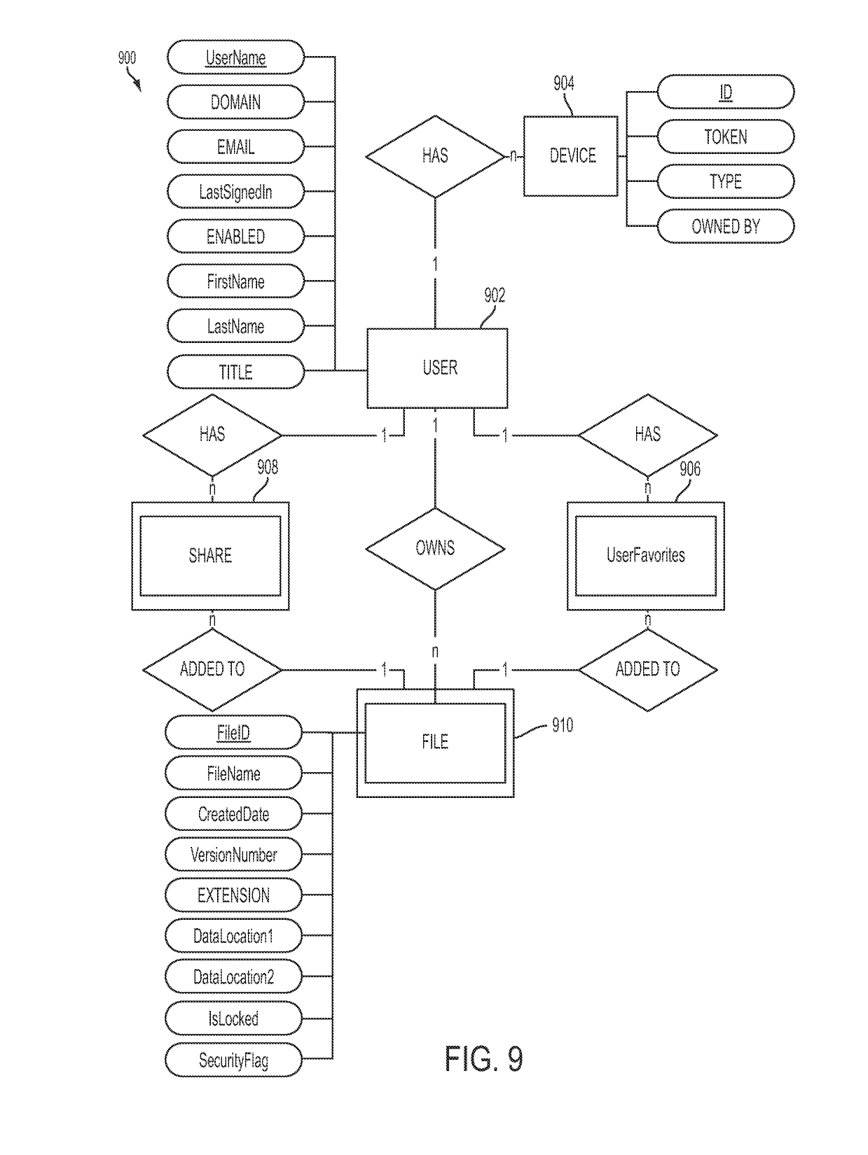

FIG. 9 is a block diagram illustrating stored information regarding data stored in a redundant storage solution according to one embodiment of the disclosure. A database 900 may include a table of users 902. Each user may have information stored, such as a username, a domain, an email, a date and time the user was last signed in, a Boolean indicating whether the account is enabled, a first name, a last name, and a title. Each user in the table of users 902 may be linked to one or more devices in a device table 904. Each device may have information stored, such as an identifier, a token, a type, and an indication of who owns the device. Each user in the table of users 902 may also be assigned one or more shares in the table 908. Each user may also be associated as an owner of one or more files in a table of files 910. Each of the files may have information stored, such as a file identifier, a filename, a created date, a version number, an extension, a data location, a security flag, and an indicator of whether the file is locked. The files may also be assigned to shares in the share table 908. Each user in the user table 902 may further have one or more linked user favorites in a table of favorites 906. The favorites may be linked to one or more files in the table of files 910.

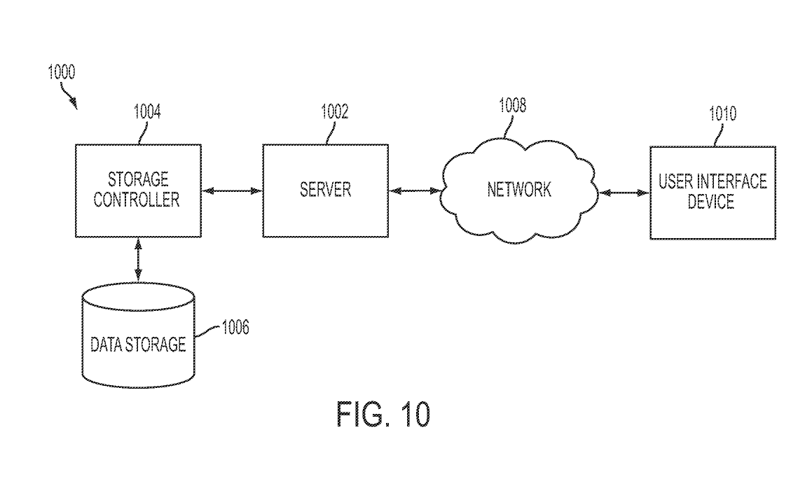

FIG. 10 illustrates one embodiment of a system 100 for an information system, including a system for storing data in a cloud storage solution. The system 1000 may include a server 1002, a data storage device 1006, a network 1008, and a user interface device 1010. The server 1002 may also be a hypervisor-based system executing one or more guest partitions. In a further embodiment, the system 1000 may include a storage controller 1004, or storage server configured to manage data communications between the data storage device 1006 and the server 1002 or other components in communication with the network 1008. In an alternative embodiment, the storage controller 1004 may be coupled to the network 1008.

In one embodiment, the user interface device 1010 is referred to broadly and is intended to encompass a suitable processor-based device such as a desktop computer, a laptop computer, a personal digital assistant (PDA) or tablet computer, a smartphone or other a mobile communication device having access to the network 1008. When the device 1010 is a mobile device, sensors (not shown), such as a camera or accelerometer, may be embedded in the device 1010. When the device 1010 is a desktop computer the sensors may be embedded in an attachment (not shown) to the device 1010. In a further embodiment, the user interface device 1010 may access the Internet or other wide area or local area network to access a web application or web service hosted by the server 1002 and may provide a user interface for enabling a user to enter or receive information.

The network 1008 may facilitate communications of data between the server 1002 and the user interface device 1010. The network 1008 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

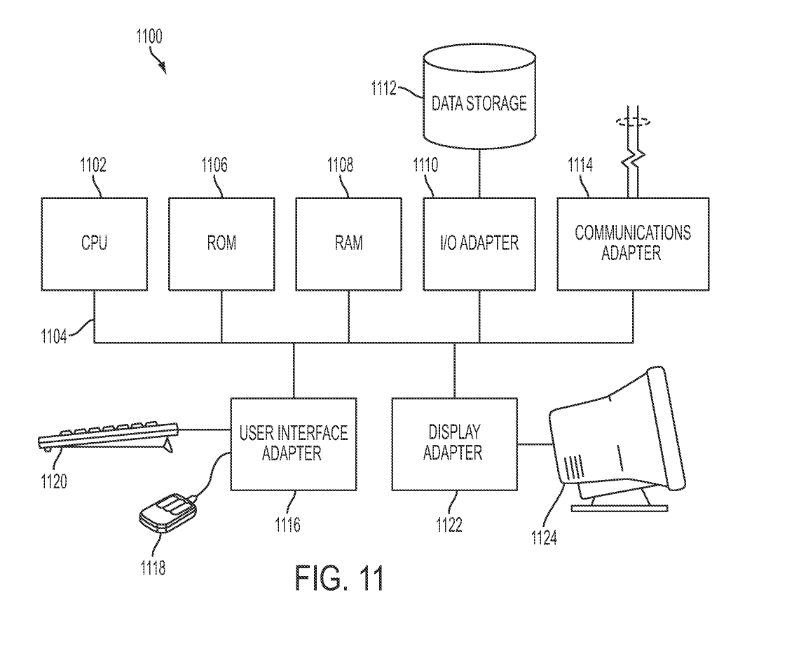

FIG. 11 illustrates a computer system 1100 adapted according to certain embodiments of the server 1002 and/or the user interface device 1010. The central processing unit (“CPU”) 1102 is coupled to the system bus 1104. The CPU 1102 may be a general purpose CPU or microprocessor, graphics processing unit (“GPU”), and/or microcontroller. The present embodiments are not restricted by the architecture of the CPU 1102 so long as the CPU 1102, whether directly or indirectly, supports the operations as described herein. The CPU 1102 may execute the various logical instructions according to the present embodiments.

The computer system 1100 also may include random access memory (RAM) 1108, which may be synchronous RAM (SRAM), dynamic RAM (DRAM), synchronous dynamic RAM (SDRAM), or the like. The computer system 1100 may utilize RAM 1108 to store the various data structures used by a software application. The computer system 1100 may also include read only memory (ROM) 1106 which may be PROM, EPROM, EEPROM, optical storage, or the like. The ROM may store configuration information for booting the computer system 1100. The RAM 1108 and the ROM 1106 hold user and system data, and both the RAM 1108 and the ROM 1106 may be randomly accessed.

The computer system 1100 may also include an input/output (I/O) adapter 1110, a communications adapter 1114, a user interface adapter 1116, and a display adapter 1122. The I/O adapter 1110 and/or the user interface adapter 1116 may, in certain embodiments, enable a user to interact with the computer system 1100. In a further embodiment, the display adapter 1122 may display a graphical user interface (GUI) associated with a software or web-based application on a display device 1124, such as a monitor or touch screen.

The I/O adapter 1110 may couple one or more storage devices 1112, such as one or more of a hard drive, a solid state storage device, a flash drive, a compact disc (CD) drive, a floppy disk drive, and a tape drive, to the computer system 1100. According to one embodiment, the data storage 1112 may be a separate server coupled to the computer system 1100 through a network connection to the I/O adapter 1110. The communications adapter 1114 may be adapted to couple the computer system 1100 to the network 1008, which may be one or more of a LAN, WAN, and/or the Internet. The communications adapter 1114 may also be adapted to couple the computer system 1100 to other networks such as a global positioning system (GPS) or a Bluetooth network. The user interface adapter 1116 couples user input devices, such as a keyboard 1120, a pointing device 1118, and/or a touch screen (not shown) to the computer system 1100. The keyboard 1120 may be an on-screen keyboard displayed on a touch panel. Additional devices (not shown) such as a camera, microphone, video camera, accelerometer, compass, and or gyroscope may be coupled to the user interface adapter 1116. The display adapter 1122 may be driven by the CPU 1102 to control the display on the display device 1124. Any of the devices 1102-1122 may be physical and/or logical.

The applications of the present disclosure are not limited to the architecture of computer system 1100. Rather the computer system 1100 is provided as an example of one type of computing device that may be adapted to perform the functions of the server 1002 and/or the user interface device 1010. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1100 may be virtualized for access by multiple users and/or applications.

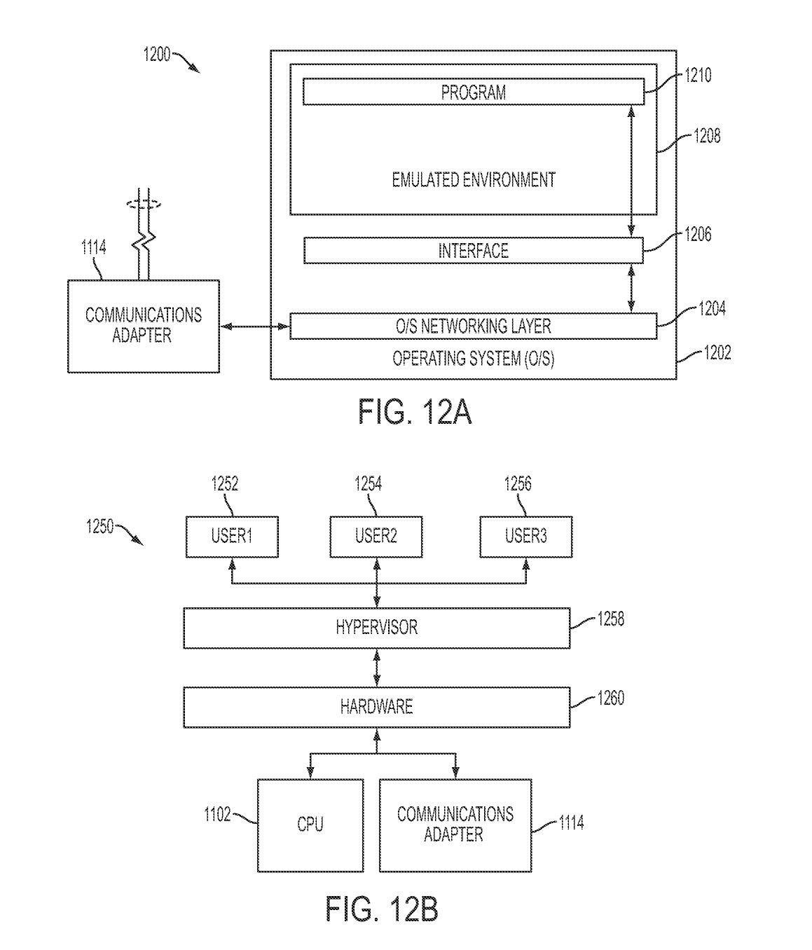

FIG. 12A is a block diagram illustrating a server hosting an emulated software environment for virtualization according to one embodiment of the disclosure. An operating system 1202 executing on a server includes drivers for accessing hardware components, such as a networking layer 1204 for accessing the communications adapter 1114. The operating system 1202 may be, for example, Linux. An emulated environment 1208 in the operating system 1202 executes a program 1210, such as CPCommOS. The program 1210 accesses the networking layer 1204 of the operating system 1202 through a non-emulated interface 1206, such as XNIOP. The non-emulated interface 1206 translates requests from the program 1210 executing in the emulated environment 1208 for the networking layer 1204 of the operating system 1202. According to one embodiment, the programs 1210 may perform the splitting and encrypting of files.

In another example, hardware in a computer system may be virtualized through a hypervisor. FIG. 12B is a block diagram illustrating a server hosing an emulated hardware environment according to one embodiment of the disclosure. Users 1252, 1254, 1256 may access the hardware 1260 through a hypervisor 1258. The hypervisor 1258 may be integrated with the hardware 1260 to provide virtualization of the hardware 1260 without an operating system, such as in the configuration illustrated in FIG. 12A. The hypervisor 1258 may provide access to the hardware 1260, including the CPU 1102 and the communications adaptor 1114.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
splitting a file into a first part and a second part;
generating parity information for the first part and the second part;
uploading the first part in a first cloud storage solution;
uploading the second part in a second cloud storage solution; and
uploading the parity information in a third cloud storage solution.

2. The method of claim 1, in which the first cloud storage solution is different from the second cloud storage solution.

3. The method of claim 1, in which the file is received from a mobile application on a mobile device.

4. The method of claim 1, in which the first cloud storage solution, the second cloud storage solution, and the third cloud storage solution comprise a redundant array of independent drives (RAID).

5. The method of claim 4, further comprising:
retrieving data from at least two of the first cloud storage solution, the second cloud storage solution, and the third cloud storage solution; and
assembling the file from the retrieved data.

6. The method of claim 5, further comprising transmitting the file to a remote device.

7. The method of claim 1, further comprising encrypting the first part and the second part before the steps of storing the first part and storing the second part.

8. A computer program product, comprising:
a non-transitory computer readable medium comprising
code to split a file into a first part and a second part;
code to generate parity information for the first part and the second part;
code to upload the first part in a first cloud storage solution;
code to upload the second part in a second cloud storage solution; and
code to upload the parity information in a third cloud storage solution.

9. The computer program of claim 8, in which the first cloud storage solution is different from the second cloud storage solution.

10. The computer program of claim 8, in which the file is received from a mobile application on a mobile device.

11. The computer program of claim 8, in which the first cloud storage solution, the second cloud storage solution, and the third cloud storage solution comprise a redundant array of independent drives (RAID).

12. The computer program of claim 11, in which the medium further comprises:
code to retrieve data from at least two of the first cloud storage solution, the second cloud storage solution, and the third cloud storage solution; and
code to assemble the file from the retrieved data.

13. The computer program of claim 12, in which the medium further comprises code to transmit the file to a remote device.

14. An apparatus, comprising:
a memory; and
a processor coupled to the memory, in which the processor is configured:
to split a file into a first part and a second part;
to generate parity information for the first part and the second part;
to upload the first part in a first cloud storage solution;
to upload the second part in a second cloud storage solution; and
to upload the parity information in a third cloud storage solution.

15. The apparatus of claim 14, in which the first cloud storage solution is different from the second cloud storage solution.

16. The apparatus of claim 14, in which the file is received from a mobile application on a mobile device.

17. The apparatus of claim 16, in which the first cloud storage solution, the second cloud storage solution, and the third cloud storage solution comprise a redundant array of independent drives (RAID).

18. The apparatus of claim 17, in which the processor is further configured:
to retrieve data from at least two of the first cloud storage solution, the second cloud storage solution, and the third cloud storage solution; and
to assemble the file from the retrieved data.

19. The apparatus of claim 18, in which the processor is further configured to transmit the file to a remote device.

20. The apparatus of claim 14, in which the processor is further configured to encrypt the first part and the second part before uploading the first part and storing the second part.
